(19) United States
(12) Patent Application Publication
(10) Pub. No.: US 2023/0309548 A1
(43) Pub. Date: Oct. 5, 2023

(54) BIRD PRESENCE INHIBITOR DEVICE AND RESPECTIVE SYSTEM

(71) Applicant: PIGEONS OUT INDÚSTRIA E COMÉRCIO DE EQUIPAMENTOS ELECTRÔNICOS LTDA, São Carlos (BR)

(72) Inventors: Giseli Diniz De Almeida MORAES, São Carlos (BR); Rubens Carlos De MORAES, São Carlos (BR)

(21) Appl. No.: 17/735,207

(22) Filed: May 3, 2022

(30) Foreign Application Priority Data
Mar. 30, 2022 (BR) 10 2022 006099 1

(51) Int. Cl. A01M 29/32; A01M 29/24

(52) U.S. Cl. CPC A01M 29/32; A01M 29/24

(57) ABSTRACT

Device and system for inhibiting the presence of birds composed of a directional and rotating electromagnetic flow generator capable of inhibiting the presence of birds due to the emission of a field that affects the birds, forcing them to change route, without the emission of noise or any risk of suffering and physical damage to these birds. It consists of a converter, first capacitor, additional capacitors, traction spring, magnetic flux carrier cable and connection coil, which may contain, if necessary, one or more radiant sets. Because of the way the converter operates, a process of generating rotating field (SPIN's) occurs, due to the presence of all the elements involved, which are emitted through the capacitors or radiant sets. Such SPIN's are a result of the elements involved, being responsible for keeping birds away from the desired perimeter, as it affects them.

### FIELD OF THE INVENTION

This invention belongs to the technological field of bird control and refers, more specifically, to a system to inhibit the presence of birds and the respective inhibitor device.

### BACKGROUND OF THE INVENTION

With the advancement of population concentration in large centers, the issue of bird control has been increasingly addressed, not only as a way to contain the inconveniences of a significant increase in the population of these agents, but also as a great ally of public health.

In this scenario, it is important to consider that the unwanted movement of birds, especially in areas of high human concentration, can represent lots of damages ranging from dirt and mechanical damage to air conditioning equipment and gutters, for example, even serious risks to human health.

Thus, it is possible to cite some measures currently used for this purpose, most often in a palliative way, such as the use of viscous gel, to prevent birds from landing in certain locations, spicules equipped with pointed elements, similar to barbed wire fences, with the objective of causing physical damage to the birds and also preventing them from landing in certain areas, protective screens, among other barriers, and, finally, the use of ultrasound emitters.

All the physical barriers mentioned above causes suffering to birds in addition to not being effective, since the birds end up adapting to these barriers and finding other ways to stay in the inappropriate place.

The viscous gel, for example, contrary to what is expected, ends up holding the birds to the place where they should be removed. These birds end up dying and decomposing on the surface, which brings even more risks of contamination. Spicules cause injuries to birds that can also lead to death, also increasing the risk of contamination.

The ultrasound technique, on the other hand, ends up being a solution with temporary effects, since the birds adapt to these waves and over time they start to live with them without major difficulties due to the low impact caused by this type of wave. This solution can even be compared with less efficient solutions such as light reflectors or even the old scarecrows.

Therefore, there are also some alternatives that represent the current state of the art and that are described in patent documents. Some examples can be seen as in the case of U.S. Pat. No. 8,905,459, which discloses a support structure to repel birds comprising a base provided with arms that extend therefrom in different directions and a non-magnetic support rod provided of a magnet, said rod oscillating in response to the wind, in such a way that said magnets generate a variable magnetic field that tends to repel birds.

The Spanish patent no. ES2060998T reveals an electrical system composed of a static pulser that provides one or more connections with high voltage pulses and low electrical power, this voltage being applied to the conductors in order to keep pigeons and other birds, away from the facades of churches, monuments, hospitals and buildings in general.

There is also the German patent document DE10110306 which discloses an electrical measuring and adjustment device, through which the electrical resistance between the conductive wires is periodically measured, in order to deliver the adequate voltage for each type of impedance, aiming at also repel birds.

Finally, it is important to cite the patent document U.S. Pat. No. 2,647,228, which proposes equipment to control the presence of birds in buildings that comprises a wire arranged in the resting places of birds, so that any bird that enters its zone of radiation immediately induces an electrical discharge in your direction.

All these patent solutions presented above cause electric shocks of different intensities to birds, which makes them illegal, as they are contrary to The Animal Welfare Act, so that actions that cause any type of mistreatment to these animals are considered crime, and can be punished with a fine, in addition to imprisonment and other types of legal sanctions provided for.

Finally, from all the inconveniences in the systems and equipment currently used, described above, it is visible the existence of a gap in the creation of a system that inhibits the presence of birds that does not cause any kind of suffering to these animals and that, in an efficient way, prevents its circulation in certain places where it will be installed.

### SUMMARY OF THE INVENTION

The fact that migratory birds orient themselves with bio-magnetic sensors has been known for decades. It is known that the navigation ability of pigeons and some other birds is based on the ability to detect variations in the Earth's magnetic field.

Baylor College of Medicine researchers, Le-Qing Wu and David Dickman, identified that the responsible for this targeting ability of pigeons is in the cells present in the bird's brain, which record detailed information about the Earth's magnetic field, such as a kind of biological compass.

Therefore, the proposed system and device aims to promote the repulsion of birds from certain locations through an electromagnetic pulse converter in SPIN's, which regulates the alternating current supplied by the grid, reducing its frequency and power to non-ionizing levels. The sinusoidal pattern of the waveform in this circuit favors the generation of the “spin” effect, which increases the amplitude of the electromagnetic waves, allowing the system to be able to drive these birds away without any suffering.

The electrical insulation obtained through the antennas (radiant elements) represents a great technological advance for this field due to the diversity of possible formats and locations to be protected against the presence of birds, since these radiant elements are made of high-quality materials. electrical insulation, in addition to great flexibility and resilience, making it possible to customize the device according to the area to be protected, such as windows or places with easy human access, without the risk of electric shock.

### BRIEF DESCRIPTION OF THE DRAWINGS

FIG. 1 represents the complete system placed on a roof without the presence of radiant elements.

FIG. 2 represents a radiating element, in one of the possible conformations, in a circular shape.

FIG. 3 represents the converter of the present system in isolation.

FIG. 4 represents the capacitor of the present system in isolation.

FIG. 5 represents the first capacitor with coil applied.

FIG. 6 represents the first capacitor with coil applied and sequential connection with the subsequent capacitor.

FIG. 7 represents a flowchart with the steps of the bird presence inhibitor system.

### DETAILED DESCRIPTION OF THE INVENTION

The present device is composed of a converter (1), first capacitor (2), additional capacitors (2n), traction spring (3), magnetic flux carrier cable (5) and connection coil (6), being able to contain, if necessary, one or more radiant sets (4).

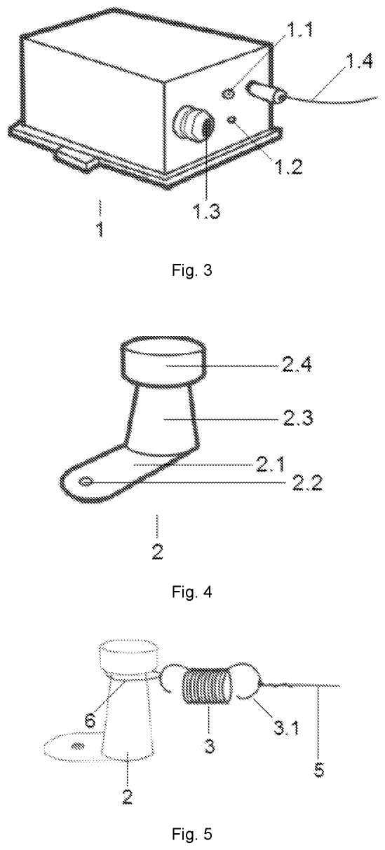

The converter, represented in FIG. 3, is, in a preferential form of execution, equipped with a potentiometer (1.1) for manual adjustment of the power according to the dimensions of the surface to be protected, LED operation indicator (1.2), power outlet from the grid (1.3) and various power cables for capacitors (2) (2n) and radiant sets (4) for supplying alternating current and consequent generation of electromagnetic field.

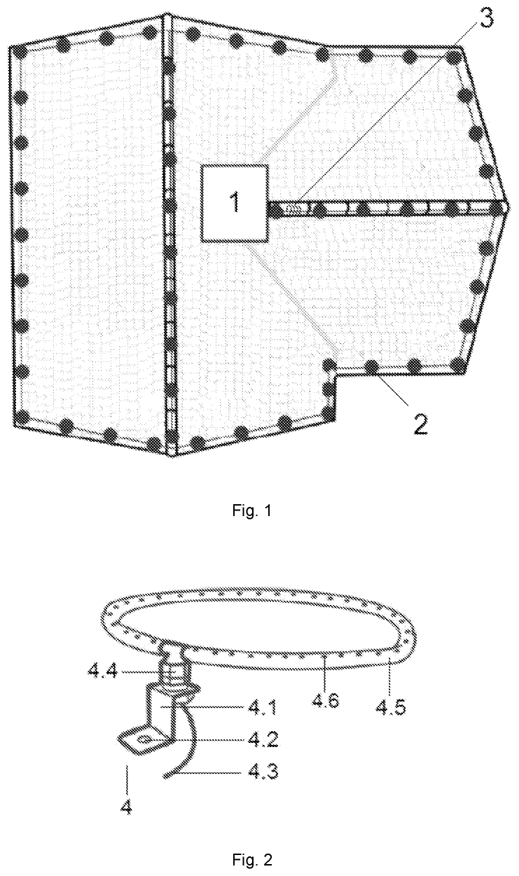

In an exemplary assembly, as can be seen in FIG. 1, the converter (1) is arranged in the center of the web of capacitors (2) (2n), from where the magnetic flux carrier cable (5) starts connects by means of the traction spring (3) to the coil (6) arranged between the body (2.3) and the head (2.4) of the first capacitor (2).

The capacitor (2) (2n), shown in FIG. 4, is composed of a base (2.1) equipped with an orifice (2.2), on which the capacitive body (2.3) and head (2.4) are arranged.

The capacitors (2) (2n) can be fixed in the structures with the most varied dispositions. Each capacitor (2) (2n) is fixed at the desired perimeters maintaining an average spacing of 2 meters between them. Preferably, in order to guarantee greater stability, the capacitors (2) (2n) can be fixed to the structures by means of fixing pins or screws inserted in the connection hole (2.2) present in the base (2.1), as shown in FIG. 4.

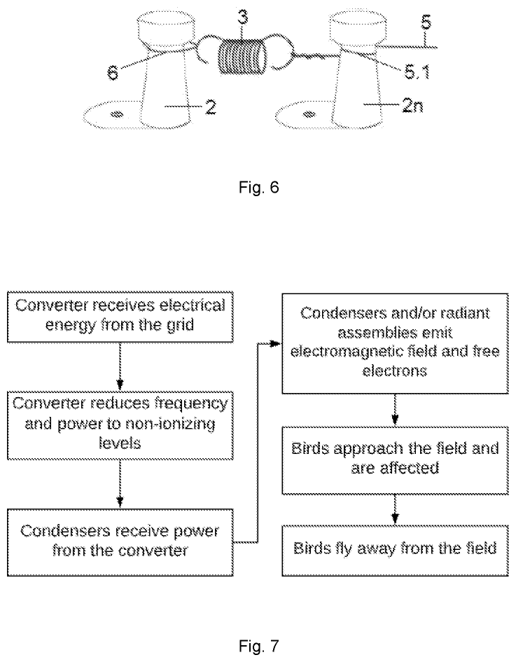

For the arrangement of the first capacitor (2) on the surface to be protected, it is recommended that its base (2.1) be arranged opposite to the initial direction of the additional capacitors (2n), ensuring that the pressure exerted by the carrier cable of magnetic flux (5) is contained, keeping the capacitor (2) stabilized, as can be seen in FIGS. 5 and 6.

Similarly to the first capacitor (2), the last capacitor (2n) of the set must also be fixed with the base (2.1) arranged in the opposite direction to the electromagnetic flux carrier cable, also verifiable in FIG. 6.

After arranging the web of capacitors (2) (2n) according to the desired design, the coil (6) must be inserted into the initial capacitor (2) and connected to the spring (3) through the connection ends (3.1), establishing the electromagnetic connection between the first capacitor (2) and the last capacitor (2n) and the proper voltage adequacy between the electromagnetic flux carrier cable (5) and the coil (6), as shown in FIG. 6.

Next, the electromagnetic flux carrier cable (5) can be arranged over each capacitor (2n) with a single connection turn (5.1) clockwise, until in the last capacitor (2n), the electromagnetic flux carrier cable electromagnetic flux (5) is completely wound without leaving any residue. Both the clockwise arrangement of the connection loop (5.1) and the final winding of the cable (5) serve to ensure the best possible electromagnetic flow, as is well known.

The flow of electrical energy present in the capacitors (2) (2n), being either positive or negative, due to the symmetric rectification caused by the converter (1), generates the “spin” effect, that is, electrical oscillations that provide a rotating electromagnetic field capable of reaching up to 60 centimeters in height, this effect being fundamental to carry out the removal of birds.

The radiant set (4) has the function of directing the electromagnetic pulses to certain places from which the birds are desired, however, access is not possible through the traditional arrangement of the capacitors (2) (2n) or in that the traditional installation can present some risk of electric shock due to the proximity of the movement of people, such as in windows or doors.

For this purpose, the radiant assembly (4) preferably consists of a radiant element (4.5) with high pressure external coating, with a preferential circumference of 1.20 m, connected by means of a retention element (4.4), preferably the PG9 type connector, being fed by a connection cable (4.3) of high isolation connected to the converter (1) through one of the electromagnetic flux carrier cables (5), transporting the electromagnetic flux generated by the converter (1) to the inside the radiating element (4.5).

As seen in FIG. 2, the radiant element (4.5) has several radiant holes (4.6), preferably 1 mm, in its outer layer, providing the radiation of the electromagnetic flux. In a preferred execution model, the distance between the various holes must be at least 7 mm, due to the wavelength generated by the converter, allowing the control of the electromagnetic field flux with high efficiency, avoiding power losses.

The fixing of the radiant element (4.5) is made through the hole (4.2) in the metallic support (4.1) of the radiant set (4). The fact that the support (4.1) is metallic is fundamental, not only to provide support, but also to enable an adequate grounding of the set.

The radiant element (4.5) is made of flexible material, and can freely assume different formats, according to the area to be protected against the presence of birds, as can be seen in FIG. 2, in which the radiant element (4.5) is formed in a circle.

After fully assembled, the proposed device provides a pulsating symmetrical direct current through the converter (1) fed with a preferred nominal voltage that can vary from 90 to 235 volts, consuming an average power at full load of approximately 14 watts.

The converter (1) operates with a primary frequency of 120 hertz, and in the feedback process, this frequency can reach 30 mega Hertz, limited to the current applied in the electronic circuit, due to the arrangement of the capacitors (2) (2n), and the frequency control occurs automatically.

However, the operating power of the converter (1) must be manually regulated, via a potentiometer (1.1), according to the total desired area of protection for each type of installation, considering an output current of the electrical pulses of approximately 5 m A/h as a pulse output voltage of approximately 1.5 kV.

Because of the way this system operates, there is a process of emission of free electrons by the capacitors (2) (2n) and radiant sets (4) or metallic cables of any kind, through high-insulation cabling. These free electrons are launched omnidirectionally, reaching average heights of up to 60 centimeters.

The aforementioned flow of free electrons is responsible for keeping the birds away from the desired perimeter, as it causes a momentary discomfort that leads to flight disorientation. This is the reason why birds do not approach locations with this kind of energy.

The system that operates the device comprises the six steps below:
(A) Converter (1) receives electrical energy from the grid;
(B) Converter (1) adapts frequency and power to non-ionizing levels;
(C) Capacitors (2) and (2n) receive energy from the converter (1);
(D) Capacitors (2) and (2n) and/or radiant set (4) convert electromagnetic pulses into SPIN's;
(E) Birds approaching the rotating field are affected by the SPIN's;
(F) Birds move away from the rotating field and do not approach the protected area.

The SPIN's generation effect is achieved due to an LRC set, that is, inductance, through a coil (6) consisting of only one turn; resistance, through the characteristic resistance of the transport cables themselves (5); and capacitance, caused by the application of capacitors (2) (2n) in the set. This whole set is necessary to obtain the desired energy field, that is, capable of keeping the birds away.

The figures presented as well as the description provided herein do not have the power to limit the ways of implementing the system and device proposed herein, serving only as an illustrative and preferential basis for this solution. Therefore, it is possible that there are other equivalent forms that do not escape the revealed scope of protection.

This descriptive report presented a system and device that inhibits the presence of birds composed of a device that generates a directional and rotating electromagnetic flow capable of inhibiting the presence of birds due to the emission of an electromagnetic frequency that affects the orientation of the flight, forcing it to those to change route, without the emission of noise or any risk of suffering and physical damage to these birds, endowed with novelty, inventive step, descriptive sufficiency, industrial application and, consequently, covered with all the essential requirements for granting the privilege claimed.

1. A device for inhibiting the presence of birds comprising:
(a) a converter equipped with a potentiometer, a LED indicator, a power socket for connection to a grid and a power cable;
(b) a traction spring equipped with connector ends, a magnetic flux carrier cable and a coil;
(c) multiple capacitors consisting of a base equipped with an orifice, including a capacitive body and a head mounted on the orifice;
(e) an LRC set converts electromagnetic pulses into SPIN's through an inductance of the coil of a single turn, a resistance of the flux carrier cables and a capacitance of the said capacitors.

2. The device in accordance with claim 1 further comprising a radiant assembly having a support with a connection hole; the assembly consisting of a radiant element, equipped with radiant holes, connected by a retaining element, powered by a cable connection connected to the converter by one of the electromagnetic flux carrier cables.

3. The device in accordance with claim 2 wherein the radiant element is made of flexible material and capable of freely assuming different shapes, according to an area to be protected against the presence of birds.

4. The device in accordance with claim 1 wherein the retaining element is a PG9 type connector.

5. The device in accordance with claim 1 wherein the electromagnetic flux carrier cables are placed over each of the multiple capacitors with a single clockwise turn.

6. A system for inhibiting the presence of birds comprising the following steps:
(A) a converter receives electrical energy from a grid;
(B) the converter adapts frequency and power to non-ionizing levels;
(C) multiple capacitors receive power from the converter;
(D) the multiple capacitors and/or a radiant assembly convert electromagnetic pulses into SPINs,
(E) birds approaching the rotating field are affected by the SPINs; and
(F) the birds move away from the rotating field and do not approach a protected area.
